(19) United States
(12) Patent Application Publication
(10) Pub. No.: US 2011/0011005 A1
(43) Pub. Date: Jan. 20, 2011

(54) Reinforced door frame construction for a vehicle

(76) Inventors: Martin C. Halliwell, Wheatley (GB); Robin W. Warmington, Oxford (GB)

Correspondence Address: BROOKS KUSHMAN P.C., 1000 TOWN CENTER, TWENTY-SECOND FLOOR, SOUTHFIELD, MI, 48075, US

(21) Appl. No.: 12/460,123

(22) Filed: Jul. 14, 2009

(51) Int. Cl. B60J 5/04; B23P 11/00; B32B 37/12

(52) U.S. Cl. 49/502; 29/428; 156/60

(57) ABSTRACT

A reinforced door frame construction for a vehicle and a method of manufacturing the same. The door panel assembly includes an inner surface and an outer surface where the inner surface has a receiving portion disposed thereon. In addition, the door panel assembly has a reinforcing member which is at least partially engaged and securable to the receiving portion in order to reinforce the structural rigidity of the door panel. In order to secure the reinforcing member to the receiving portion, an adhesive may be applied between the receiving portion and the reinforcing member.

### BACKGROUND OF THE INVENTION

The present invention relates to a reinforced door frame construction for a vehicle and a method of manufacturing the same.

Structural reinforcements are commonly provided with a vehicle door frame assembly in order to increase the rigidity or stiffness of the door. Such reinforcements are typically rolled sections or extrusions and are joined to the door frame to provide rigidity to the stamped door frame. The joining technology for these types of reinforcements to the door frame is generally done by welding, and in particular, fusion welding. The welding process can be slow and cumbersome. In addition, high heat input from the welding process can cause distortion or even weakness in the regions surrounding the weld joint. Consequently, the welding process may create function and appearance problems with the finished parts. All of these problems contribute to poor quality door frames and increased cost, due to scrap and grinding or re-work of assembled door frames in order to have acceptable function and appearance of the weld joints and finished doors.

Whereas conventional door frames provided with reinforcing members must be welded, the present invention provides a product and manufacturing process free from the need of welding. The reinforced door panel assembly of a vehicle wherein the assembly increases the rigidity or stiffness of the door is provided wherein the door corresponds to an opening in the vehicle.

### BRIEF DESCRIPTION OF THE DRAWINGS

FIG. 1 illustrates a perspective view of an exemplary automobile vehicle including a reinforced door panel assembly of the present invention.

FIGS. 2 and 3 illustrate a perspective view of a reinforced door panel assembly of the present invention.

FIGS. 4, 5 and 6 illustrate a cross-sectional view of the reinforcement region of a reinforced door panel assembly.

FIG. 7 illustrates a detailed view of a locating and retaining feature of feature of the door panel assembly.

FIG. 8 illustrates a flow chart detailing a method of manufacturing of a door panel assembly of the present invention.

### DETAILED DESCRIPTION OF THE PREFERRED EMBODIMENT(S)

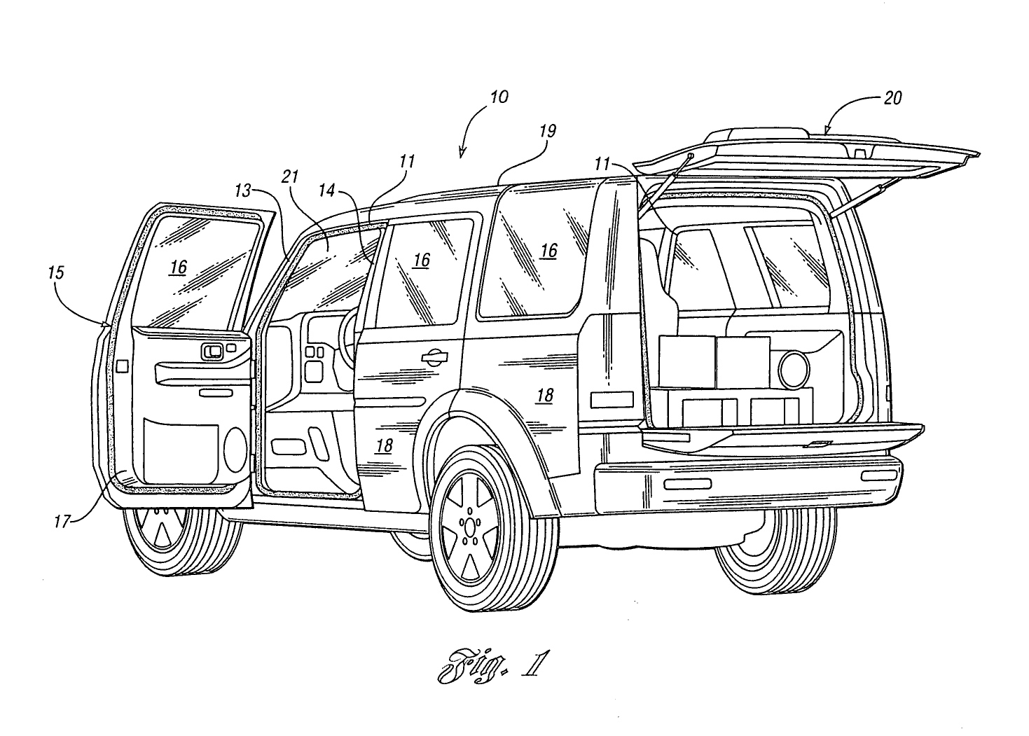

FIG. 1 illustrates an exemplary vehicle 10 which includes a reinforced door panel assembly of the present invention. The vehicle 10 may include one or more side door assemblies 15 and a rear door or hatch assembly 20. The side door assemblies 15 and the rear door or hatch assembly 20 may be configured to correspond to an opening 11 in a vehicle 10. The side door assembly 15 or the rear door assembly 20 may include an interior trim panel 17 which may be securable to the interior surface of the door panel assembly, as well as an outer body panel 18 which may be configured to be an outer appearance surface of the vehicle which may be painted.

Conventionally, a motor vehicle 10 may have an A-pillar 13, a B-pillar 14, and as well as a roof 19. The A-pillar 13 supports the windshield 21 on either side of the vehicle 10, and the A-pillar 13 may be the area where a front side door assembly would be hingedly secured. The B-pillar 14 in a four-door vehicle, as illustrated in FIG. 1, provides support between the front and the rear side doors. The B-pillar 14 may be where a rear side door assembly is typically hingedly secured and a front side door could latch and lock in a closed position. Also, as shown in FIG. 1, the rear door assembly 20 may be hingedly secured adjacent the roof 19, however, the rear door assembly 20 may be hinged along any of the sides of the opening. In addition, a side door assembly 15 or rear door assembly 20 could be fitted with a window 16. It is contemplated that side door assembly 15 and rear door assembly 20, as well as any door assembly, could include the reinforced door panel assembly of the present invention.

FIG. 2 illustrates a reinforced door panel assembly of the present invention in greater detail. The door panel assembly 30 may include a door frame 31 which, in turn, may be comprised of an upper frame panel 32 as well as a lower frame panel 35. The upper frame panel generally defines a window opening 33 and may be adjacent the roof 19.

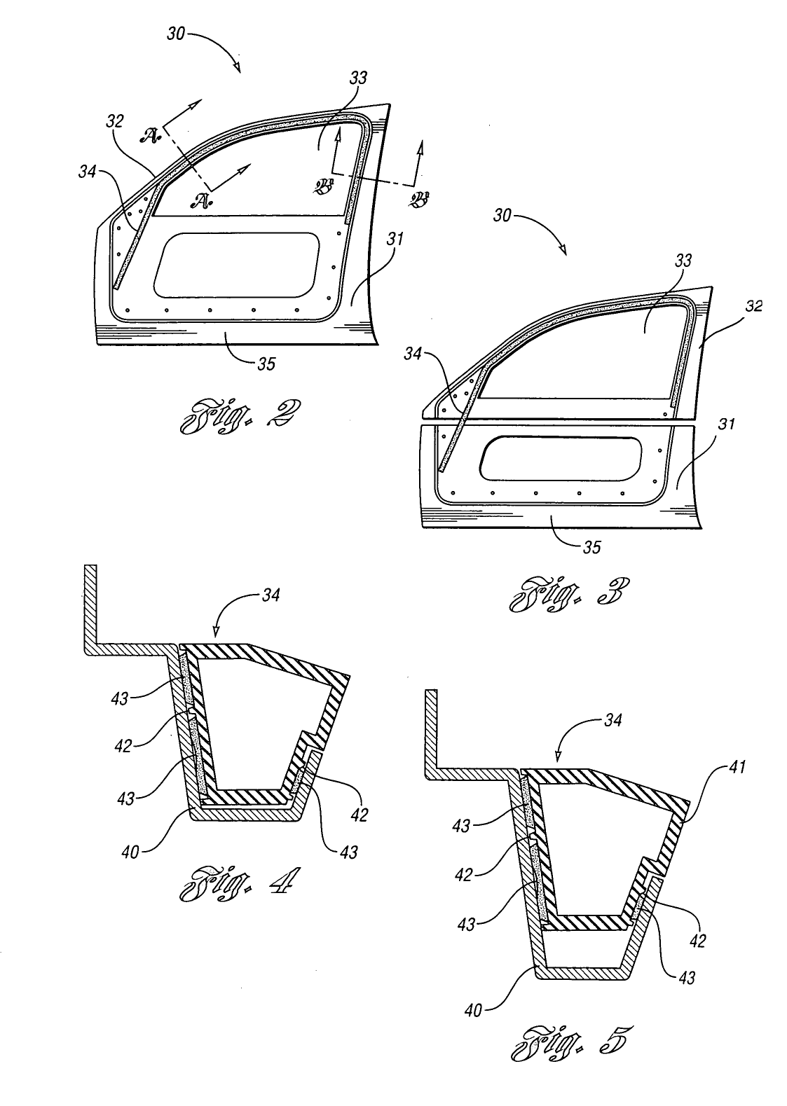

FIG. 3 illustrates an alternate version of a door panel assembly in which the door frame may be a two-piece frame comprised of a separate upper frame panel 32 and a lower frame panel 35. Whether the door frame 31 is a unitary structure, like in FIG. 2, or a multi-panel assembly as in FIG. 3, the lower frame panel 35 typically includes a plurality of openings for access to door mechanisms such as window regulators as well as the lock, latch, or handle mechanisms for opening, closing or locking the vehicle door, as well as any other components typically housed in a door assembly.

Conventionally, the door panel assembly may be made by stamping a sheet of metal to define a shape that corresponds to a vehicle's contours and the shape of a door opening 11. The door panel assembly 30 could also be formed with alternate processes, such as injection molding or formed with composite material, for example. The door panel assembly 30 pictured here is that of a side door assembly 15, although the door panel assembly 30 could be configured to a rear door assembly 20 or another vehicle door assembly not shown. The door panel assembly 30 may be configured to attach an interior trim panel 17 along the inner surface of door panel assembly 30. The door panel assembly 30 may also have an outer body panel 18 disposed on the outer surface of the door panel assembly 30.

The door panel assembly 30 may include at least one reinforcing member 34 to increase the structural rigidity of the door frame 31. Whereas the reinforcing member 34 is pictured along the periphery of the window opening 33, the reinforcing member may be alternatively located anywhere on the door panel assembly where increased structural rigidity is desired. As such, it is also contemplated that the reinforcing member may be located on an the interior region of the door panel assembly 30. The reinforcing member 34 may be oriented vertical, or may be transverse to the door panel, such as an side intrusion beam to provide impact resistance in addition to structural rigidity.

The reinforcing member 34 may be extruded to form a shape adapted to cooperate and engage with the receiving portion 40. Conventionally, the reinforcing member may be extruded metal and have a tubular cross-section. However, the reinforcing member 34 may be formed from any material, or by any process which is suitable to form a receiving member 34 with a shape adapted to cooperate and mate with the cross-section of the receiving portion 40. The longitudinal shape of the reinforcing member may be formed engage with the longitudinal shape of a corresponding receiving portion 40, or may be at least partially engaged with a receiving portion 40. The reinforcing member 34 may be of a single piece which may be secured to both the lower frame panel 35 and the upper frame panel 32 or there may be more than one reinforcing members 34 disposed at different locations on the door frame 31.

FIG. 4 illustrates a section of the door along section A-A depicting the reinforcement region of a reinforced door panel assembly 30 showing a cross-section of the retaining portion 40 and the reinforcing member 34 of the door frame 31. The retaining portion 40, as depicted here, may be a generally U-shaped channel adapted to cooperate with the reinforcing member 34. In the one embodiment, the door frame 31 may be generally a stamped metal door frame and the receiving portion 40 is formed into the door frame using a roller clinching, punch or stamping system.

Since the claimed invention eliminates the need for the welding process, it is also contemplated that the door frame 31 and the reinforcing member 34 could be dissimilar materials. In the case that the door frame 31 may be, for example, injection molded, and the receiving portion 40 may be integrally molded or formed in the door frame 31.

Additionally, while the receiving portion 40 illustrated in FIGS. 4-6 is generally a U-shaped channel, the receiving portion 40 may also be configured to cooperate with any shaped reinforcing member 34. Further, where one embodiment is a receiving portion 40 integrally formed on the inner surface of the door frame 31, it is also contemplated that the receiving portion 40 may be secured to the inner surface of the door frame 31. The door frame 31 may also have several receiving portions 40 to engage one or more reinforcing members 34 or it may have one unitary receiving portion 40.

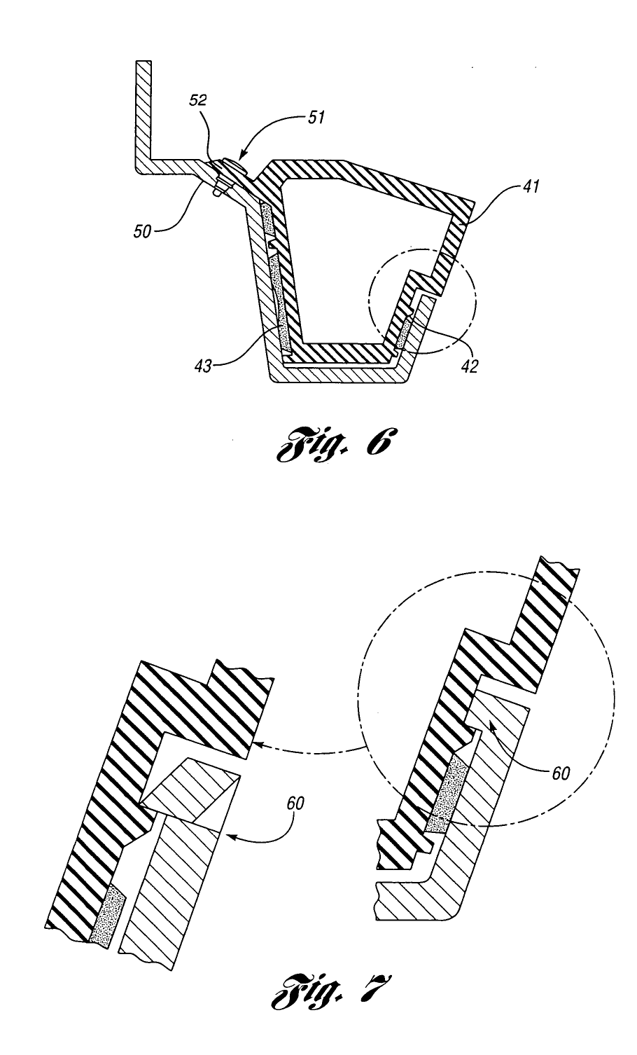

The corresponding shape and dimensions of the receiving portion 40 may vary along different areas of the door frame 31. For example, FIG. 5 shows a cross section of a reinforcing region in a door frame 31 along section B-B where the receiving portion 40 is deeper so that the reinforcing member 34 fits outboard of the door frame 31 in order to increase the I-value or bending strength in these areas. A cross-section as illustrated in FIG. 5 may be employed on sections of the frame where the bending moment is higher or where vehicle dimensions and packaging constraints allow for a larger receiving portion 40. The receiving portion 40 may have a cross-section as shown in section B-B in FIG. 5 on the areas of the door frame 31 adjacent the latch or the B-pillar 14, in the example of a front side door assembly, or along the lower frame panel 35. In this configuration, the reinforcing member 34 may not be fully seated due to the increased depth of the receiving member 40.

Conversely, a shallower receiving portion 40, as show section A-A in FIG. 4 may be preferred in some sections of the door frame 31, such as adjacent the A-pillar 13, in the example of a front side door assembly, or adjacent the roof 19 and along of the window opening 33, where design requirements may not allow for a deeper receiving portion 40. In these locations, the reinforcing member 34 may be fully seated in the receiving portion 40.

Alternative cross-section geometry of the reinforcing members 34 may be employed to cooperate with a different geometry of receiving portions 40 and locating features 60. The reinforcing member 34 may be formed by extrusion or roll formed in order to create a shape adapted to engage with the receiving portion 40 and the door frame 31. The reinforcing member 34 may also have a shoulder feature 41 which cooperates with an edge of the receiving portion 40. In cooperating with the receiving portion 40 the shoulder feature 41 may be designed to allow the correct amount of engagement of the reinforcing member 34 with the retaining member 40.

In order to secure the reinforcing member 34, an adhesive 43 may be used to attach the reinforcing member 34 to the receiving portion 40 or to the door frame 31. Adhesive may be a two-part epoxy with a short cure time or that cures under ambient conditions. Alternatively, a single part adhesive could be used where the adhesive curing is achieved in a subsequent paint process, or any additional curing or thermosetting process. Additionally, any adhesive compatible with the base materials in association with the applicable curing processes could be used.

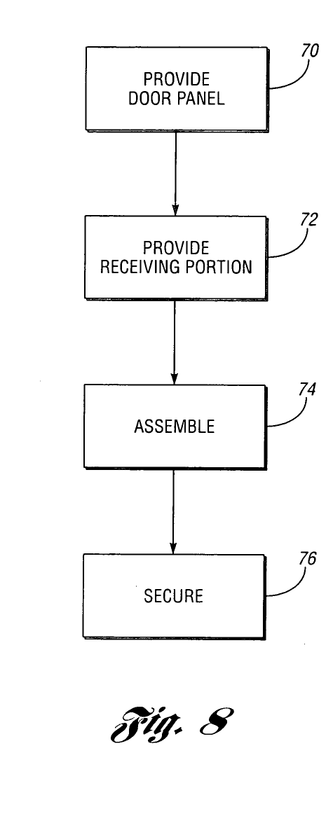

The door frame 31 may also include retaining features for holding the reinforcing member 34 into the receiving portion 40 until the adhesive 43 is completely cured. One method, as illustrated in FIG. 7, is where the receiving portion 40 or the door frame 31 includes a locating feature 60. When the reinforcing member 34 engages with the receiving portion 40, the locating feature 60 may deform so that it cooperates and restrains the reinforcing member 34. The reinforcing member may have a rib 42 located along the reinforcing member 34 with which the locating feature 60 engages. The rib 42 may be a continuous feature or it may be placed at a series of locations along the reinforcing member 34. Likewise, the locating feature 60 may be a continuous feature or it may be placed at a series of locations along the receiving portion 40. The locating feature 60 may also be adapted to facilitate assembly and to receive and guide the reinforcing member 34 into engagement with the receiving portion 40.

FIG. 6 depicts an alternate method of holding the reinforcing member 34 in place while the adhesive 43 cures. In this embodiment, the reinforcing member 34 may also have a securement tab 52 which mates with a flange 50 in the door frame 31. The securement tab 52 and the flange 50 may be held together with a fastener 51. The fastener 51 may be a series of screws, rivets, self-piercing fasteners or another fastening mechanism which holds the reinforcing member 34 in place while the adhesive 43 cures.

FIG. 8 is a flowchart illustrating a method for manufacturing a door panel assembly of the present invention. In the first step 70, a door panel may be provided by conventionally stamping a metal blank, or the door panel may be provided alternate manufacturing process such as injection molding material such as plastic, or forming a composite material. As such, the door panel may be provided in any material or by any process suitable for manufacturing a door panel for a vehicle.

In step 72 of the process, a receiving portion is provided on the door. The receiving portion may be a channel formed on the inner surface of the door panel. Alternatively, the receiving portion may be a separate component which is attached to the door frame. The receiving portion may be formed on the door panel by roller clinching, roll forming, or integrally molded or any other process suitable for forming a channel of the desired geometry.

In step 74 of the process, the reinforcing member is assembled with the retaining member. The reinforcing member may be pressed into the receiving portion, or slidably assembled with the receiving portion, or assembled in a process suitable for mating the reinforcing member with the receiving portion. The reinforcing member may be only assembled with a portion of the receiving portion, or the door panel may have multiple retaining portions in which a reinforcing member or multiple reinforcing members cooperate.

In step 76 of the process, the reinforcing member is secured to a door frame. The reinforcing member may be secured and retained solely by the engagement of the reinforcing member with the receiving portion. Or the door frame may be provided with a locating feature which deforms to cooperate with and restrain the reinforcing member. Additionally, the reinforcing member may be secured to the door frame with a fastener such as a screw, rivet, self-piercing fastener, or other mechanical fastener. The reinforcing member may also be secured to the door frame or receiving portion with an adhesive.

While embodiments of the invention have been illustrated and described, it is not intended that these embodiments illustrate and describe all possible forms of the invention. Rather, the words used in the specification are words of description rather than limitation, and it is understood that various changes may be made without departing from the spirit and scope of the invention. Additionally, the features of various implementing embodiments may be combined to form further embodiments of the invention.

What is claimed is:

1. A door panel assembly for a vehicle comprising:
a door panel configured for securement and adjacent an opening in the vehicle, the door panel having an outer surface and an opposing inner surface, the inner surface having one or more receiving portions disposed thereon; and
a reinforcing member at least partially engaged with and securable to one or more receiving portions,
wherein the reinforcing member reinforces the structural rigidity of the door panel.

2. The door panel assembly of claim 1 wherein the one or more receiving portions are a unitary channel.

3. The door panel assembly of claim 1 wherein the one or more receiving portions are secured to the inner surface of the door panel.

4. The door panel assembly of claim 1 wherein the one or more receiving portions are integrally formed on the inner surface of the door panel.

5. The door panel assembly of claim 1 wherein the one or more receiving portions are located adjacent the periphery of the inner surface of the door panel.

6. The door panel assembly of claim 1 wherein the inner surface of the door panel includes at least one locating feature to facilitate assembly of the reinforcing member with the one or more receiving portions.

7. The door panel assembly of claim 1 wherein an adhesive is applied to one of the reinforcing member or the one or more receiving portions to secure the reinforcing member to the door panel.

8. A vehicle door comprising:
a door frame configured for securement and adjacent an opening in the vehicle, the frame having an outer surface and an opposing inner surface, the inner surface having at least one channel disposed on the periphery of the inner surface of the frame; and
a reinforcing member fixedly secured to at least a portion of the channel,
wherein, the reinforcing member reinforces the structural rigidity of the vehicle door.

9. The door of claim 8 channel is secured to the inner surface of the door frame.

10. The door of claim 8 wherein the channel is integrally formed on the inner surface of the door frame.

11. The door of claim 8 wherein an adhesive is applied to one of the channel or the channel to secure the reinforcing member to door frame.

12. A method for manufacturing a door assembly of a vehicle, the method comprising the steps of:
providing a door panel having an outer surface and an opposing inner surface;
providing one or more receiving portions disposed on the inner surface of the door panel;
assembling a reinforcement member at least partially with the one or more receiving portions; and
securing the reinforcement member to the door panel.

13. The method of claim 12 wherein the receiving portion is a unitary channel formed on the inner surface of the door panel.

14. The method of claim 12 wherein the receiving portion is secured to the inner surface of the door panel.

15. The method of claim 12 wherein the receiving portion is integrally formed on the inner surface of the door panel.

16. The method of claim 12 wherein the receiving portion is formed by roller clinching.

17. The method of claim 12 wherein the reinforcing member is extruded to form a shape adapted to cooperate with the receiving portion.

18. The method of claim 12 wherein the reinforcing member is roll formed to form a shape adapted to cooperate with the receiving portion.

19. The method of claim 12 further comprising the step of applying an adhesive between the door frame and the reinforcing member.

20. The method of claim 12 wherein the receiving portion is disposed about the periphery of the inner surface of the door panel.
